(19) United States
(12) Patent Application Publication
(10) Pub. No.: US 2015/0199083 A1
(43) Pub. Date: Jul. 16, 2015

(54) CONSOLIDATED SYSTEM TRAY

(71) Applicant: Google Inc., Mountain View, CA (US)

(72) Inventors: Alexander Friedrich Kuscher, San Francisco, CA (US); John Nicholas Jitkoff, Palo Alto, CA (US)

(73) Assignee: Google Inc., Mountain View, CA (US)

(21) Appl. No.: 13/789,478

(22) Filed: Mar. 7, 2013

(51) Int. Cl. G06F 3/0482

(52) U.S. Cl. CPC G06F 3/0482

(57) ABSTRACT

A method for providing a consolidated system tray includes determining a plurality of menu items for displaying in a system tray of a computer operating system, where the plurality of menu items correspond to settings for using the computer operating system. The method also includes determining status of at least one setting corresponding to each of the plurality of determined menu items, and generating a first graphic user interface that combines the determined plurality of menu items and the determined status of the at least one setting corresponding to each of the plurality of determined menu items. The method further includes providing the generated first graphic user interface for display to the user, where each of the plurality of determined menu items displayed in the first graphic user interface is selectable by a user. Systems and machine-readable media are also provided.

### BACKGROUND

Operating systems typically have on their main user interface (UI) screen a system tray that includes icons representing various systems or application settings.

### SUMMARY

The subject disclosure relates generally to system trays of operating systems, and more particularly to providing a consolidated system tray for a computer operating system.

The subject disclosure relates to a computer-implemented method for providing a consolidated system tray for a computer operating system that includes determining a plurality of menu items for displaying in a system tray of a computer operating system, where the a plurality of menu items correspond to settings for using the computer operating system. The method also includes determining a status of at least one setting corresponding to each of the a plurality of determined menu items, and generating a first graphic user interface that combines the determined a plurality of menu items and the determined status of the at least one setting corresponding to each of the a plurality of determined menu items. The method further includes providing the generated first graphic user interface for display to the user, where each of the a plurality of determined menu items displayed in the first graphic user interface is selectable by a user.

These and other aspects can include one or more of the following features. The method may also include receiving a user selection from among the plurality of determined menu items of the displayed first graphic user interface, determining a sub-menu for displaying to the user based on the selected menu item, where the sub-menu comprises one or more selectable options associated with the selected menu item, generating a second user interface for displaying the determined sub-menu, and providing the generated second user interface for display to the user. Also, in the step of providing the generated second user interface for display to the user, the second user interface may replace the displayed first user interface.

Additionally, the method may also include generating a message corresponding to at least one of the displayed menu items and displaying the generated message in place of the displayed menu item corresponding to the generated message. The method may also include providing a single icon for display to the user, and receiving a user selection on the displayed single icon, where the first user interface for displaying the plurality of determined menu items to the user is displayed to the user in response to the received user selection on the single icon. The single icon may collectively display at least one of a battery level, network status, or a thumbnail image associated with the user.

Further, the plurality of menu items may be determined based on at least one of a predetermined default menu items, system configuration or user activity. The plurality of menu items may be determined based on at least a frequency at which the user accesses the settings for using the computer operating system. The method may also include identifying a system configuration associated with the computer operating system, where the plurality of menu items are determined based on at least the identified system configuration. The plurality of determined menu items displayed in the first graphic user interface may include menu items for directly adjusting the settings for using the computer operating system.

The present disclosure also relates to a system for providing a consolidated system tray for a computer operating system that includes a menu item determination module configured to determine plurality of menu items for displaying in a system tray of a computer operating system based on at least one of a predetermined default menu items, system configuration or user activity, where the plurality of menu items correspond to settings for using the computer operating system. The system also includes a status of settings determination module configured to determine a status of at least one setting corresponding to each of the plurality of determined menu items, and a graphic user interface generation module configured to generate a first graphic user interface that combines the determined plurality of menu items and the determined status of the at least one setting corresponding to each of the plurality of determined menu items. The system further includes a graphic user interface display module configured to provide the generated first graphic user interface for display to the user, where each of the plurality of determined menu items displayed in the first graphic user interface is selectable by a user.

These and other aspects can include one or more of the following features. The menu item determination module may be further configured to determine a sub-menu for displaying to the user, in response to receiving a user selection from among the plurality of determined menu items of the displayed first graphic user interface. The sub-menu comprises one or more selectable options associated with the selected menu item. The graphic user interface generation module may be further configured to generate a second user interface for displaying the determined sub-menu. The graphic user interface display module may be further configured to provide the generated second user interface for display to the user. The generated second user interface may be provided for display to the user by replacing the displayed first user interface with the second user interface.

Additionally, the system may also include a message generation module configured to generate a message corresponding to at least one of the plurality of displayed menu items and a message display module configured to display the generated message in place of the displayed menu item corresponding to the generated message. Also, the graphic user interface display module may be further configured to provide the first user interface for display to the user, in response to a user selection received on a single icon that is provided for display to the user. The single icon may collectively display at least one of a battery level, network status, or a thumbnail image associated with the user.

Further, the plurality of menu items may be determined based on at least a frequency at which the user accesses the settings for using the computer operating system. The menu item determination module may be further configured to identify a system configuration associated with the computer operating system, where the plurality of menu items are determined based on at least the identified system configuration. Also, the plurality of determined menu items displayed in the first graphic user interface may include menu items for directly adjusting the settings for using the computer operating system.

The present disclosure further relates to a machine-readable medium comprising instructions stored therein, which when executed by processors, cause the processors to perform operations that include determining a plurality of menu items for displaying in a system tray of a computer operating system, where the plurality of menu items correspond to settings for using the computer operating system. The operations also include determining a status of at least one setting corresponding to each of the plurality of determined menu items, generating a first graphic user interface that combines the determined plurality of menu items and the determined status of the at least one setting corresponding to each of the plurality of determined menu items, and providing the generated first graphic user interface for display to the user, where each of the plurality of determined menu items displayed in the first graphic user interface is selectable by a user. The operations further include receiving a user selection from among the plurality of determined menu items of the displayed first graphic user interface, determining a sub-menu for displaying to the user based on the selected menu item, where the sub-menu comprises one or more selectable options associated with the selected menu item, generating a second user interface for displaying the determined sub-menu, and providing the generated second user interface for display to the user by replacing the displayed first user interface with the second user interface.

These and other aspects may provide one or more of the following advantages. Users may view statuses of settings for using a computer operating system more efficiently. The users may also access, manage and receive information associated with the settings, more efficiently.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purposes of explanation, several implementations of the subject technology are set forth in the following figures.

FIG. 1 is a diagram of an example system for providing a consolidated system tray for a computer operating system.

FIG. 2 illustrates a flow diagram of an example process for providing a consolidated system tray for a computer operating system.

FIG. 3 conceptually illustrates diagrams showing example graphic user interfaces for providing a consolidated system tray for a computer operating system.

FIG. 4 conceptually illustrates an example of a system for providing a consolidated system tray for a computer operating system.

FIG. 5 conceptually illustrates an electronic system with which some aspects of the subject technology are implemented.

### DETAILED DESCRIPTION

In the following detailed description, numerous specific details are set forth to provide a full understanding of the present disclosure. It will be apparent, however, that the implementations of the present disclosure may be practiced without some of these specific details. In other instances, structures and techniques have not been shown in detail so as not to obscure the disclosure.

Operating systems of computer systems typically have on their main user interface (UI) screen (e.g., a desktop screen) a system tray that includes icons representing various system or application settings for using the computer systems. For example, the system tray of the UI screen may include an icon showing Wi-Fi signal strength, an icon showing battery level, an icon showing indexing status of a system's search feature, or an icon for accessing a settings menu for an application. These icons are arranged randomly and each icon has its own menu and function. Therefore, the system tray quickly becomes very cluttered with icons and inefficient for accessing the functionalities provided by the icons.

Methods and systems for providing a consolidated system tray are provided herein. A UI element is provided on the UI-end of an operating system, which the user may select by, for example, clicking, to access a consolidated system tray. The operating system may be installed on a computer system (e.g., laptop computer, smart phone, desktop computer, or tablet computer). The UI element for accessing the consolidated system tray may be an icon showing a select number of types of information regarding the status of a computer system. For example, the UI element may be an icon collectively displaying the battery level, network status and a thumbnail image representing the user who is currently signed in on the computer system. Regardless of the type of information displayed by the icon, selecting the icon by clicking or otherwise engaging the icon brings up another single UI element showing a more detailed view of the consolidated system tray.

The initial view of the detailed consolidated system tray may include several menu items corresponding to different system or application settings. Selecting a menu item may provide in-line access to sub-menus for the selected menu item. The sub-menus for the selected menu item may include one or more selectable options for adjusting the system or application settings associated with the selected menu item. The initial view of the consolidated system may also include menu items for directly adjusting system or application settings.

The menu items on the initial view and on other different views of the consolidated system tray may be determined based on various factors such as, for example, default settings, system configuration, or user actions. In addition, the menu items for the various settings may also show notifications that are associated with the menu items to the user as in-line notifications.

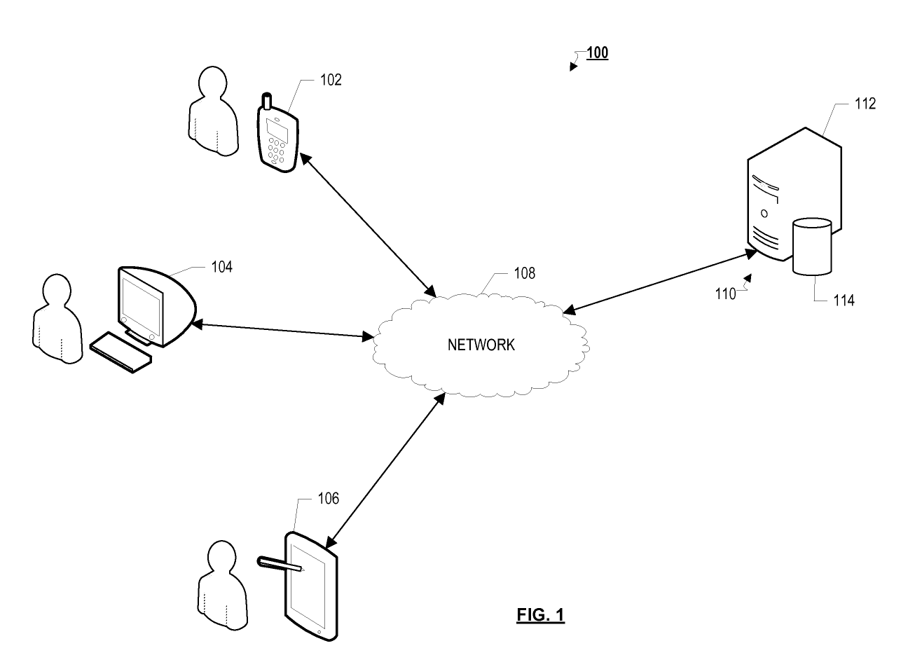

FIG. 1 illustrates an example client-server network that provides for a consolidated system tray. A network display 100 includes a number of electronic devices 102, 104 and 106 communicably connected to a server 110 by a network 108. Server 110 includes a processing device 112 and a data store 114. Processing device 112 executes computer instructions stored in data store 114, for example, instructions to determine a plurality of menu items for displaying in a system tray of a computer operating system, where the plurality of menu items correspond to settings for using the computer operating system, and determining a status of at least one setting corresponding to each of the plurality of determined menu items. The computer instructions may also include instructions for generating a first graphic user interface that combines the determined plurality of menu items and the determined status of the at least one setting corresponding to each of the plurality of determined menu items, and providing the generated first graphic user interface for display to the user, wherein each of the plurality of determined menu items displayed in the first graphic user interface is selectable by a user.

Data store 114 may store information pertaining to, for example, the determined plurality of menu items or the status of at least one setting that correspond to each of the plurality of determined menu items. Server 110 may host an application within which some of the processes discussed herein are implemented. In some example aspects, electronic devices or client devices, as used interchangeably herein, 102, 104 and 106 can be computing devices such as smartphones, PDAs, portable media players, tablet computers, televisions or other displays with one or more processors coupled thereto or embedded therein, or other appropriate computing devices that can be used for running a mobile application.

Electronic devices 102, 104 and 106 may have one or more processors embedded therein or attached thereto, or other appropriate computing devices that can be used for accessing a host, such as server 110. In the example of FIG. 1, electronic device 102 is depicted as a smartphone, electronic device 104 is depicted as a television, and electronic device 106 is depicted as a tablet computer. A client is an application or a system that accesses a service made available by a server which is often (but not always) located on another computer system accessible by a network. Some client applications may be hosted on a website, whereby a browser is a client. Such implementations are within the scope of the subject disclosure, and any reference to client may incorporate a browser and reference to server may incorporate a website.

The system (e.g., hosted at any of electronic devices 102, 104 or 106, or server 110), determines a plurality of menu items for displaying in a system tray of a computer operating system. The plurality of menu items correspond to settings for using the computer operating system. The determination of the plurality of menu items may be based on at least one of a predetermined default setting, system configuration or user activity. The system also determines a status of at least one setting corresponding to each of the plurality of determined menu items, and generates a first graphic user interface that combines the determined plurality of menu items and the determined status of the at least one setting corresponding to each of the plurality of determined menu items. The system further provides the generated first graphic user interface for display to the user. Each of the plurality of determined menu items displayed in the first graphic user interface is selectable by a user.

The system may also receive a user selection from among the plurality of determined menu items of the displayed first graphic user interface, and determine a sub-menu for displaying to the user based on the selected menu item. The sub-menu comprises one or more selectable options associated with the selected menu item. The system may further generate a second user interface for displaying the determined sub-menu, and provide the generated second user interface for display to the user. The users may interact with the system with any of the electronic devices 102, 104 or 106. Data pertaining to the determined plurality of menu items and/or a status of at least one setting corresponding to each of the plurality of determined menu items may be stored in, for example, data store 114.

Each electronic device 102, 104 and 106 may be a client device or a host device. In some example aspects, server 110 can be a single computing device such as a computer server. In other implementations, server 110 can represent more than one computing device working together to perform the actions of a server computer (e.g., cloud computing). The server 110 may host the web server communicationally coupled to the browser at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

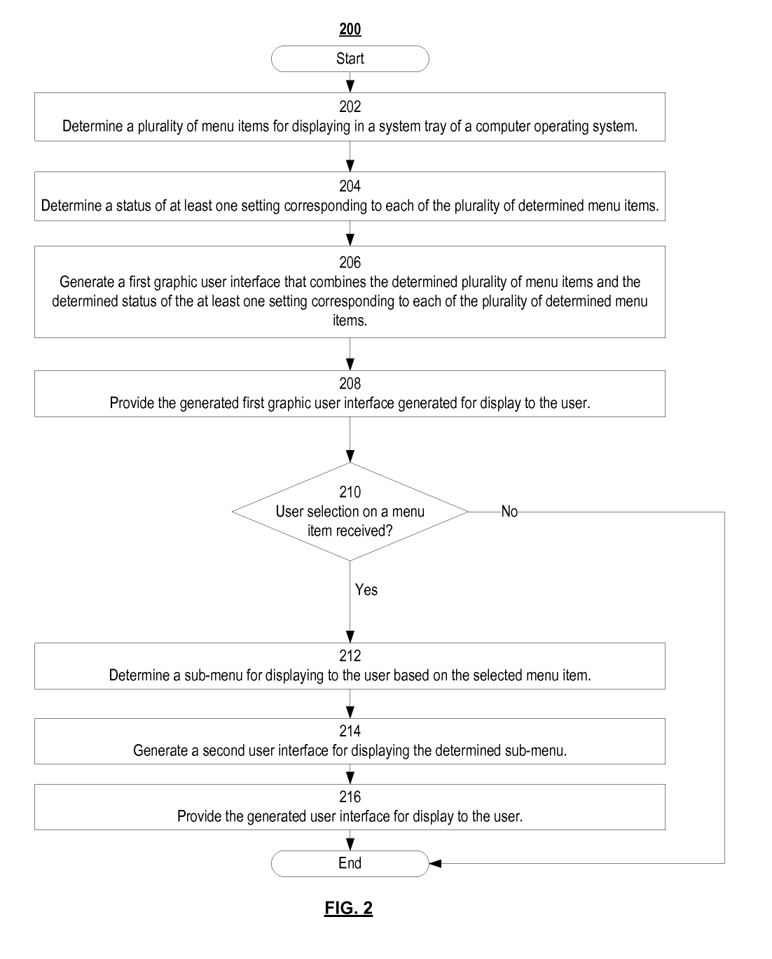

FIG. 2 illustrates a flow diagram of an example process 200 for providing a consolidated system tray. Process 200 begins and at block 202, the system determines a plurality of menu items for displaying in a consolidated system tray of a computer operating system. The plurality of menu items correspond to settings for using the computer operating system. The settings for using the computer operating system may include, for example, user account settings, network settings, Bluetooth settings, and other general settings (e.g., settings for adjusting wall paper, language settings, keyboard settings, or sound settings) for using the operating system.

The menu items determined at block 202 may be determined based on various factors such as, for example, default settings, system configuration, or user actions. For example, a set of menu items may be predetermined for displaying in an initial view of the consolidated system tray by default. Specifically, network settings and user account settings may be predetermined to be displayed by default in the initial view of the consolidated system tray.

As another example, system configuration may be taken into account when determining the menu items to display in the initial view of the consolidated system tray. Specifically, if the computer system is equipped with a Bluetooth antenna, the presence of the Bluetooth antenna may be detected and a menu item for Bluetooth settings may also be determined to be displayed in the initial view. If the user has two keyboard layouts enabled in the operating system (e.g., a US keyboard and a Japanese keyboard layout), a menu item for showing the current keyboard layout and switching between different keyboard layouts may also be determined for display.

As yet another example, the menu items determined for display in the initial view of the consolidated system tray may also be determined based on user activity. Specifically, if the user has switched between different keyboard layouts five times within a predetermined amount of time, a menu item for changing the keyboard layout may be determined for display in the initial view, because it is likely the user will switch keyboard layout again soon. On the other hand, if the user has not switched keyboard layout for the past two days, the menu item for switching keyboard layout may no longer be determined for display in the initial view. When such menu item is not determined for display in the initial view, however, its functionality may be accessible in the sub-menus of other menu items shown in the initial view (e.g., a sub-menu of the general system settings menu item). The sub-menus of the various menu items will be discussed in more detail below.

At block 204, the system determines a status of at least one setting corresponding to each of the plurality of menu items that are determined at block 202. The determined status may indicate, for example, signal strength of a Wi-Fi network to which the computer system is connected, names of Bluetooth devices that are paired and/or connected to the computer system, the name of an account that the user has logged into, or system volume.

At block 206, the system generates a first graphic user interface (“GUI”) for displaying an initial view of the consolidated system tray. The first GUI combines the plurality of menu items determined at block 202 and the status of the at least one setting (corresponding to each of the plurality of determined menu items) determined at block 204. At block 208, the system provides the first graphic user interface generated at block 206 for display to the user. Each of the plurality of determined menu items displayed in the first graphic user interface is selectable by a user.

In an aspect of the subject technology, the first GUI that is displayed at block 208 may be displayed in response to the user clicking on, or otherwise engaging, a single UI element. The single UI element may be, for example, an icon representing the system tray for the computer operating system. The system tray icon may display certain information regarding the status of the computer system. Information that is displayed on the system tray icon may include, for example, battery level, network status, or a thumbnail image representing the user who is currently signed in to the computer system. Regardless of the information displayed on the system tray icon, clicking on or otherwise engaging anywhere on the system tray icon causes the system to display the first GUI discussed above.

The first GUI generated at block 206 and displayed at block 208 combines the menu items and the statuses of settings such that the menu items may show the statuses of the settings corresponding to the menu items. For example, the first GUI may display menu items for user account settings, network settings, and Bluetooth settings. The first GUI may also display the user name of the current user account, Wi-Fi signal strength, and the name of Bluetooth devices that are connected to the computer system, next to the corresponding menu items. Therefore, the user may quickly view the statuses associated with each of the menu items that are displayed on the first GUI. The first GUI may display the statuses associated with all menu items, some of the menu items, or no menu items.

The first GUI may also display messages associated with the menu items that are displayed in the first GUI. The messages may be in-line notifications that concern the status of at least one setting for the menu items. In the example above, when the computer system is connected to the Internet using a 3G or 4G network, and the user's data allowance has run out, the network settings menu item may be replaced with a notification that reads “You have run out of your data allowance.” Clicking on the notification may bring up a view for connecting to a Wi-Fi network instead of the 3G or 4G network. As another example, when the computer system is in a public area and a free Wi-Fi network is available, the network settings menu item may be replaced with a notification which reads “A free Wi-Fi network is available. Would you like to connect?” Clicking on the notification may bring up a view for connecting to the free Wi-Fi network. Additionally, the first GUI may further include menu items for directly adjusting system or application settings. For example, the first GUI may include a menu item for adjusting the system volume or adjusting the screen brightness.

At block 210, the system determines whether a user selection from among the plurality of determined menu items of the first GUI displayed at block 208, is received. For example, the system determines whether a user selection is received on any one of the menu items for user account settings, network settings, or Bluetooth settings that are displayed on the first GUI. If, at block 210, determination is made that no user selection is received, process 200 ends. If, at block 210, determination is made that a user selection is received on a menu item, at block 212, the system determines a sub-menu for displaying to the user. The sub-menu is determined based on selected menu item. The system also generates, at block 214, a second GUI for displaying the sub-menu determined at block 212, and at block 216, provides the second GUI for display to the user.

The second GUI generated at block 214 and displayed at block 216 displays one or more selectable options associated with the user-selected menu item selected from the first GUI. In the example above, if a user selection is received on the menu item for network settings, the system determines a sub-menu for the network settings, and generates a second GUI for displaying selectable options adjusting various network-related settings. The selectable options may include for example, options for turning Wi-Fi on/off, selecting a Wi-Fi network to which to connect, or turning airplane mode on/off. The system may display the generated second GUI to the user such that the second GUI replaces the first GUI that was displayed to the user. Alternatively, the system may also display the generated GUI next two the first GUI such that both the first GUI and the second GUI are visible to the user.

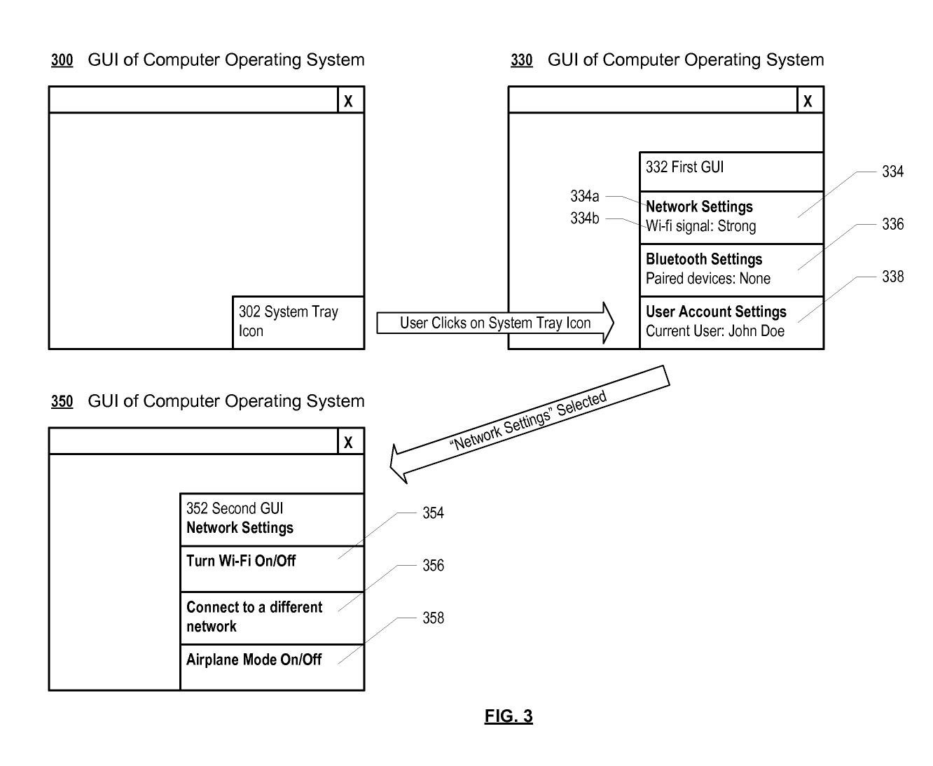

FIG. 3 conceptually illustrates diagrams 300, 330 and 350 showing example graphic user interfaces (“GUI's”) for providing a consolidated system tray according to an aspect of the subject technology.

Diagram 300 shows a GUI for a computer operating system which displays a system tray icon 302. While not shown, the system tray icon 302 may display certain information such as, for example, battery level, network status, or a thumbnail image representing the user who is currently signed in to the computer system. Diagram 300 shows that the system tray icon 302 is displayed on the lower right corner of the GUI for the computer operating system. However, the system tray icon 302 may be displayed anywhere on the GUI for the computer operating system.

If the user engages the system tray icon 302 anywhere on the system tray icon 302 (e.g., clicks on or touches the system tray icon), the system displays the first GUI 332, as shown in diagram 330. The first GUI 332 displays menu items 334, 336 and 338 corresponding to network settings, Bluetooth settings and user account settings, respectively. Each menu item may display a description of the menu item, and statuses of settings that are associated with the menu item. For example, the network settings menu item 334 displays a description 334a which describes that the menu item 334 is for “Network Settings” and a status 334b which shows that the Wi-Fi signal is currently “strong.”

If the user selects a menu item from the first GUI 332, the system displays a second GUI showing sub-menus for the selected menu item. Diagram 350 shows that the user has selected the menu item 334 for network settings. In diagram 350, the first GUI 332 is replaced with a second GUI 352, which displays sub-menus for adjusting various settings related to network settings. Specifically, the second GUI 352 displays sub-menus 354 for turning Wi-Fi on/off, 356 for connecting to a different network, and 358 for turning airplane mode on/off.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing display. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

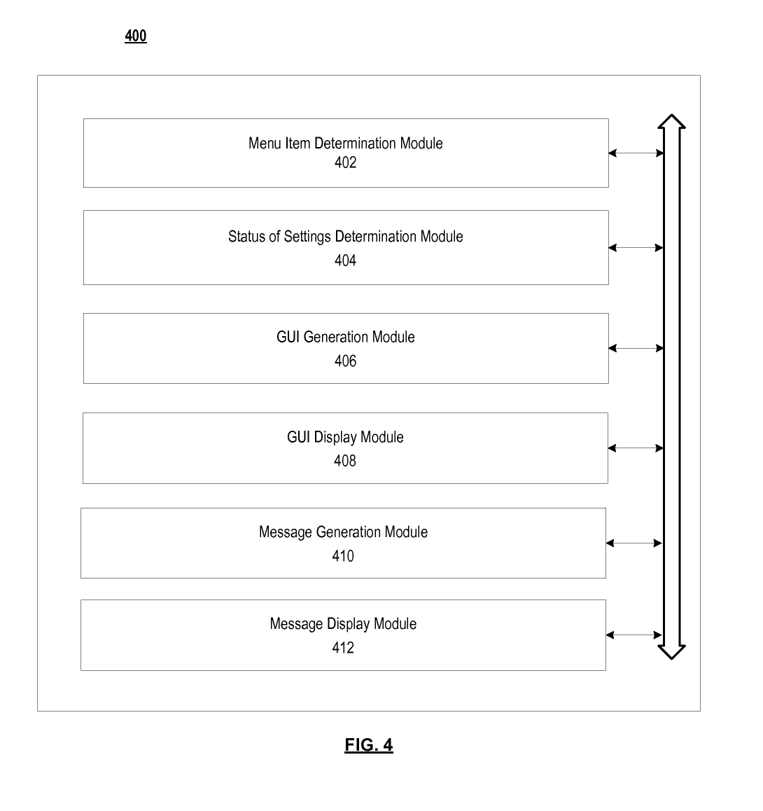

FIG. 4 illustrates an example of system 400 for providing a consolidated system tray, in accordance with various aspects of the subject technology. System 400 comprises a menu item determination module 402, a status of settings determination module 404, a GUI generation module 406 and a GUI display module 408. The system may also comprise a message generation module 410 and a message display module 412.

The menu item determination module 402 is configured to determine a plurality of menu items for displaying in a system tray of a computer operating system. The plurality of menu items correspond to settings for using the computer operating system. The menu item determination module 402 may also be configured to determine a sub-menu for displaying to the user, in response to receiving a user selection from among the one ore more determined menu items. The sub-menu may include one or more selectable options associated with the selected menu item. The status of settings determination module 404 is configured to determine a status of at least one setting corresponding to each of the plurality of determined menu items.

The GUI generation module 406 is configured to generate a first graphic user interface that combines the plurality of menu items determined by the menu item determination module 402, and the status of the at least one setting corresponding to each of the plurality of determined menu items determined by the status of settings determination module 404. The GUI generation module 406 may also be configured to generate a second user interface for displaying a sub-menu that may be determined by the menu-item determination module 402. The GUI display module 408 is configured to provide the first graphic user interface generated by the GUI generation module 406 for display to the user. Each of the plurality of determined menu items displayed in the first graphic user interface is selectable by a user. The GUI display module 408 may also be configured to provide for display to the user the second user interface that may be generated by the GUI generation module 406.

The system may also include a message generation module 410 configured to generate a message corresponding to at least one of the displayed menu items, and a message display module 412 configured to display the generated message in place of the displayed menu item corresponding to the generated message.

These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

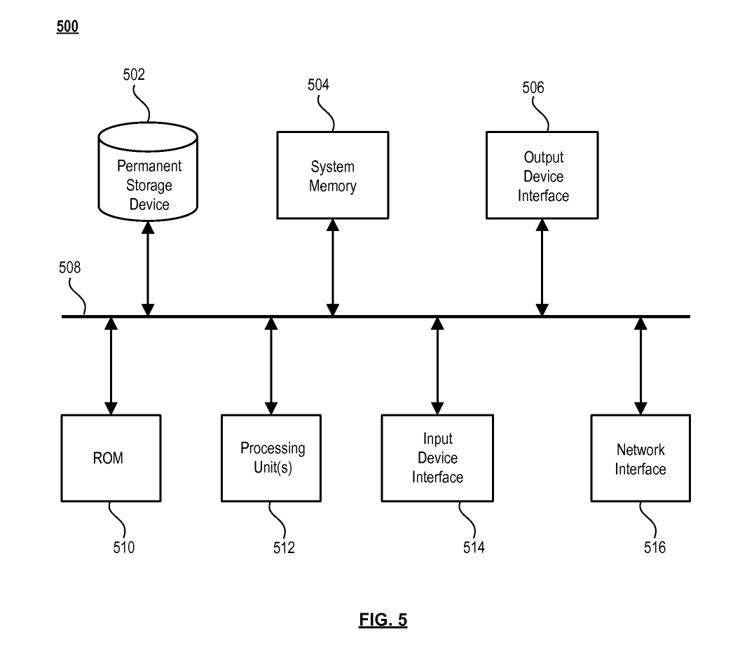

FIG. 5 conceptually illustrates an electronic system with which some aspects of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as televisions or other displays with one or more processors coupled thereto or embedded therein, or other appropriate computing devices that can be used for running an application. Some implementations include devices such as a touch screen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a device having a display device, e.g., televisions or other displays with one or more processors coupled thereto or embedded therein, or other appropriate computing devices that can be used for running an application, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method for providing a consolidated system tray for a computer operating system, the method comprising:
determining a plurality of menu items for displaying in a system tray of a computer operating system, wherein the plurality of menu items correspond to settings for using the computer operating system;
determining a status of at least one setting corresponding to each of the plurality of determined menu items;
generating a first graphic user interface that combines the determined plurality of menu items and the determined status of the at least one setting corresponding to each of the plurality of determined menu items; and
providing the generated first graphic user interface for display to the user, wherein each of the plurality of determined menu items displayed in the first graphic user interface is selectable by a user.

2. The method of claim 1, further comprising:
receiving a user selection from among the plurality of determined menu items of the displayed first graphic user interface;
determining a sub-menu for displaying to the user based on the selected menu item, wherein the sub-menu comprises one or more selectable options associated with the selected menu item;
generating a second user interface for displaying the determined sub-menu; and
providing the generated second user interface for display to the user.

3. The method of claim 2, wherein in the step of providing the generated second user interface for display to the user, the second user interface replaces the displayed first user interface.

4. The method of claim 1, further comprising generating a message corresponding to at least one of the displayed menu items and displaying the generated message in place of the displayed menu item corresponding to the generated message.

5. The method of claim 1, further comprising:
providing a single icon for display to the user; and
receiving a user selection on the displayed single icon;
wherein the first user interface for displaying the plurality of determined menu items to the user is displayed to the user in response to the received user selection on the single icon.

6. The method of claim 5, wherein the single icon collectively displays at least one of a battery level, network status, or a thumbnail image associated with the user.

7. The method of claim 1, wherein the plurality of menu items are determined based on at least one of a predetermined default menu items, system configuration or user activity.

8. The method of claim 1, wherein the plurality of menu items are determined based on at least a frequency at which the user accesses the settings for using the computer operating system.

9. The method of claim 1, further comprising identifying a system configuration associated with the computer operating system, wherein the plurality of menu items are determined based on at least the identified system configuration.

10. The method of claim 1, wherein the plurality of determined menu items displayed in the first graphic user interface includes menu items for directly adjusting the settings for using the computer operating system.

11. A system comprising:
a menu item determination module configured to determine a plurality of menu items for displaying in a system tray of a computer operating system based on at least one of a predetermined default menu items, system configuration or user activity, wherein the plurality of menu items correspond to settings for using the computer operating system;
a status of settings determination module configured to determine a status of at least one setting corresponding to each of the plurality of determined menu items;
a graphic user interface generation module configured to generate a first graphic user interface that combines the determined plurality of menu items and the determined status of the at least one setting corresponding to each of the plurality of determined menu items; and
a graphic user interface display module configured to provide the generated first graphic user interface for display to the user, wherein each of the plurality of determined menu items displayed in the first graphic user interface is selectable by a user.

12. The system of claim 11, wherein the menu item determination module is further configured to determine a sub-menu for displaying to the user, in response to receiving a user selection from among the plurality of determined menu items of the displayed first graphic user interface, wherein the sub-menu comprises one or more selectable options associated with the selected menu item;
wherein the graphic user interface generation module is further configured to generate a second user interface for displaying the determined sub-menu; and
wherein the graphic user interface display module is further configured to provide the generated second user interface for display to the user.

13. The system of claim 12, wherein the generated second user interface is provided for display to the user by replacing the displayed first user interface with the second user interface.

14. The system of claim 11, further comprising a message generation module configured to generate a message corresponding to at least one of the plurality of displayed menu items and a message display module configured to display the generated message in place of the displayed menu item corresponding to the generated message.

15. The system of claim 11, wherein the graphic user interface display module is further configured to provide the first user interface for display to the user, in response to a user selection received on a single icon that is provided for display to the user.

16. The system of claim 15, wherein the single icon collectively displays at least one of a battery level, network status, or a thumbnail image associated with the user.

17. The system of claim 11, wherein the plurality of menu items are determined based on at least a frequency at which the user accesses the settings for using the computer operating system.

18. The system of claim 11, wherein the menu item determination module is further configured to identify a system configuration associated with the computer operating system, wherein the plurality of menu items are determined based on at least the identified system configuration.

19. The system of claim 11, wherein the plurality of determined menu items displayed in the first graphic user interface includes menu items for directly adjusting the settings for using the computer operating system.

20. A machine-readable medium comprising instructions stored therein, which when executed by processors, cause the processors to perform operations comprising:
determining a plurality of menu items for displaying in a system tray of a computer operating system, wherein the plurality of menu items correspond to settings for using the computer operating system;
determining a status of at least one setting corresponding to each of the plurality of determined menu items;
generating a first graphic user interface that combines the determined plurality of menu items and the determined status of the at least one setting corresponding to each of the plurality of determined menu items;
providing the generated first graphic user interface for display to the user, wherein each of the plurality of determined menu items displayed in the first graphic user interface is selectable by a user;
receiving a user selection from among the plurality of determined menu items of the displayed first graphic user interface;
determining a sub-menu for displaying to the user based on the selected menu item, wherein the sub-menu comprises one or more selectable options associated with the selected menu item;
generating a second user interface for displaying the determined sub-menu; and
providing the generated second user interface for display to the user by replacing the displayed first user interface with the second user interface.
